(19) United States
(12) Patent Application Publication
(10) Pub. No.: US 2017/0332115 A1
(43) Pub. Date: Nov. 16, 2017

(54) VIDEO SOURCE ACCESS METHOD AND DEVICE

(71) Applicant: Tencent Technology (Shenzhen) Company Limited, Shenzhen (CN)

(72) Inventor: Cancheng ZHONG, Shenzhen (CN)

(21) Appl. No.: 15/666,381

(22) Filed: Aug. 1, 2017

Related U.S. Application Data
(63) Continuation of application No. PCT/CN2016/074820, filed on Feb. 29, 2016.

(30) Foreign Application Priority Data
Mar. 3, 2015 (CN) 201510094882.7

(51) Int. Cl. H04N 21/2343; H04N 21/234; H04N 21/64; H04N 21/845

(52) U.S. Cl. CPC H04N 21/234309; H04N 21/8456; H04N 21/23418; H04N 21/64

(57) ABSTRACT

A video source access method and a video source access device are provided. In some embodiments, the method includes acquiring an address identifier of a video source supporting a certain format, where the video source includes video data in the format carrying a timestamp; acquiring, based on the address identifier, the video data in an ascending order of the timestamp carried in the video data; converting the video data from the format into a preset common video format to obtain the video data in the common video format; and inputting the video data in the common video format to a service device to achieve an access to the video source.

### CROSS REFERENCE OF RELATED APPLICATION

This application is a continuation of International Application No. PCT/CN2016/074820, filed on Feb. 29, 2016, which claims the priority to Chinese Patent Application No. 201510094882.7, titled “VIDEO SOURCE ACCESS METHOD AND DEVICE”, filed on Mar. 3, 2015 with the State Intellectual Property Office of People's Republic of China, both of which are hereby incorporated by reference in their entireties.

### TECHNICAL FIELD

The present disclosure relates to the field of video data processing, and in particular to a video source access method and a video source access device.

### BACKGROUND

With the development of video service, various service devices into which a video source is inputted should have an access function of supporting video source in various formats. Moreover, the formats of the video source are updated frequently, and hence, in order to be compatible with the video sources in various formats, the service device should modify internal processing logic continually. For example, when a video source in a new format arrives, the service device needs to modify its processing logic to be compatible with the video source in the new format.

Since the internal processing logic of the service device is adjusted continually, the maintenance of the service device by the staff is more and more difficult. More seriously, it may result in that core business of the service device is unstable since the internal processing logic of the service device is modified continually, and meanwhile it is also not beneficial to develop the core service.

### SUMMARY

In view of this, a video source access method and a device thereof are provided in embodiments of the present disclosure. The method includes acquiring an address identifier of a video source supporting a certain format. The video source includes video data in the format carrying a timestamp. The method further includes acquiring, based on the address identifier, the video data in an ascending order of the timestamp carried in the video data. The method further includes converting the video data from the format into a preset common video format to obtain the video data in the common video format. The method further includes inputting the video data in the common video format to a service device to achieve an access to the video source.

In some embodiments, the method may further include sending a starting video transmission request to the service device. The inputting the video data in the common video format to the service device may include inputting the video data in the common video format to the service device in an ascending order of the timestamp upon reception of a starting video response returned by the service device.

In some embodiments, the method may further include detecting an availability of the video source based on the address identifier, and sending a pausing video transmission notification to the service device in a case that it is detected that the video source is unavailable.

In some embodiments, the method may further include detecting an availability of the video source based on the address identifier, and reacquiring the video data in the video source based on the address identifier after a preset time duration in a case that it is detected that the video source is unavailable.

In some embodiments, an ending video transmission notification may be sent to the service device when an ending video transmission signal is received or after video data in the common video format in the video source which carries a maximum time stamp is inputted to the service device.

In some embodiments, the method may further include assigning a unique video identifier to the video source.

In some embodiments, the method may further include setting a communication protocol, and inputting the video data in the common video format to the service device in accordance with the communication protocol.

In some embodiments, the method may further include sending an acquiring video data request to the video source after the address identifier of the video source is obtained.

In some embodiments, the method may further include separating audio data from the obtained video data, and inputting the audio data to an audio server.

In some embodiments, the service device may include at least one of a video server, a video transcoding server or a video confluence server.

A video source access device is further provided in embodiments of the present disclosure, which includes a first acquiring module, a second acquiring module, a converting module and an inputting module. The first acquiring module is configured to acquire an address identifier of a video source supporting a certain format. The video source includes video data in the format carrying a timestamp. The second acquiring module is configured to acquire, based on the address identifier, the video data in an ascending order of the timestamp carried in the video data. The converting module is configured to convert the video data from the format into a preset common video format to obtain the video data in the common video format. The inputting module is configured to input the video data in the common video format to a service device to achieve an access to the video source.

In some embodiments, the device may further include a first sending module configured to send a turn-on video transmission request to the service device. The inputting module is further configured to input the video data in the common video format to the service device in an ascending order of the timestamp upon reception of a starting video response returned by the service device.

In some embodiments, the device may further include a first detecting module and a second sending module. The first detecting module is configured to detect an availability of the video source based on the address identifier. The second sending module is configured to send a pausing video transmission notification to the service device in a case that it is detected that the video source is unavailable.

In some embodiments, the device may further include a second detecting module and a third acquiring module. The second detecting module is configured to detect an availability of the video source based on the address identifier. The third acquiring module is configured to reacquire the video data in the video source based on the address identifier after a preset time duration in a case that it is detected that the video source is unavailable.

In some embodiments, the device may further include a third sending module. The third sending module is configured to send an ending video transmission notification to the service device when an ending video transmission signal is received or after video data in the common video format in the video source which carries a maximum time stamp is inputted to the service device.

A video source access device is further provided in embodiments of the present disclosure, which includes one or more processors, and a memory. The memory has program instructions stored therein. The program instructions, when executed by the one or more processors, configure the device to execute processes including acquiring an address identifier of a video source supporting a certain format. The video source includes video data in the format carrying a timestamp. The processes further include acquiring, based on the address identifier, the video data in an ascending order of the timestamp carried in the video data. The processes further include converting the video data from the format into a preset common video format to obtain the video data in the common video format. The processes further include inputting the video data in the common video format to a service device to achieve an access to the video source.

In some embodiments, the device may further be configured to send a starting video transmission request to the service device, and input the video data in the common video format to the service device in an ascending order of the timestamp upon reception of a starting video response returned by the service device.

In some embodiments, the device may further be configured to detect an availability of the video source based on the address identifier, and send a pausing video transmission notification to the service device in a case that it is detected that the video source is unavailable.

In some embodiments, the device may further be configured to detect an availability of the video source based on the address identifier, and reacquire the video data in the video source based on the address identifier after a preset time duration in a case that it is detected that the video source is unavailable.

In some embodiments, the device may further be configured to send an ending video transmission notification to the service device when an ending video transmission signal is received or after video data in the common video format in the video source which carries a maximum time stamp is inputted to the service device.

A computer-readable storage media is further provided in an embodiment of the present disclosure. The computer-readable storage media stores program instructions. The program instructions, when executed by a processor of a computing device, configure the computing device to acquire an address identifier of a video source supporting a certain format. The video source includes video data in the format carrying a timestamp. The program instructions, when executed by a processor of a computing device, further configure the computing device to acquire, based on the address identifier, the video data in an ascending order of the timestamp carried in the video data. The program instructions, when executed by a processor of a computing device, further configure the computing device to convert the video data from the format into a preset common video format to obtain the video data in the common video format. The program instructions, when executed by a processor of a computing device, further configure the computing device to input the video data in the common video format to a service device to achieve an access to the video source.

In embodiments of the present disclosure, an address identifier of a video source supporting a certain format is obtained. The video source includes video data in the format carrying a timestamp. The video data is obtained in an ascending order of the timestamp carried in the video data based on the address identifier. The video data is converted from the format into a preset common video format to obtain the video data in the common video format. The video data in the common video format is inputted to a service device which has a requirement for an access to the video source. Compared with the conventional technology, in the present disclosure, the video source are converted from multiple formats into a common format without modifying a processing logic of the service device, the identifiable video data in the common format is provided to the service device, and access to the video source supporting various formats is achieved.

### BRIEF DESCRIPTION OF THE DRAWINGS

In order to illustrate technical solutions in embodiments of the disclosure more clearly, drawings used in the description of the embodiments are introduced briefly hereinafter. The drawings described hereinafter merely illustrate some embodiments of the disclosure, and other drawings may be obtained by those skilled in the art based on these drawings without any creative efforts.

FIG. 1 is a flowchart of a video source access method according to the present disclosure;

FIG. 2 is an interaction diagram of a video source access method applied to a big network game competition broadcasting according to the present disclosure;

FIG. 3 is a schematic structural diagram of a video source access device according to the present disclosure;

FIG. 4(a) is a deployment structural diagram of the video source access device according to a device embodiment of the present disclosure;

FIG. 4(b) is a deployment structural diagram of the video source access device according to a device embodiment of the present disclosure; and

FIG. 5 is a schematic structural diagram of a part of a server according to the present disclosure.

### DETAILED DESCRIPTION OF THE EMBODIMENTS

Technical solutions according to embodiments of the present disclosure are described clearly and completely in conjunction with the drawings in the embodiments of the present disclosure hereinafter. Apparently, the described embodiments are only a few rather than all of the embodiments of the present disclosure. Other embodiments obtained by those skilled in the art without any creative work based on the embodiments of the present disclosure fall into the scope of protection of the present disclosure.

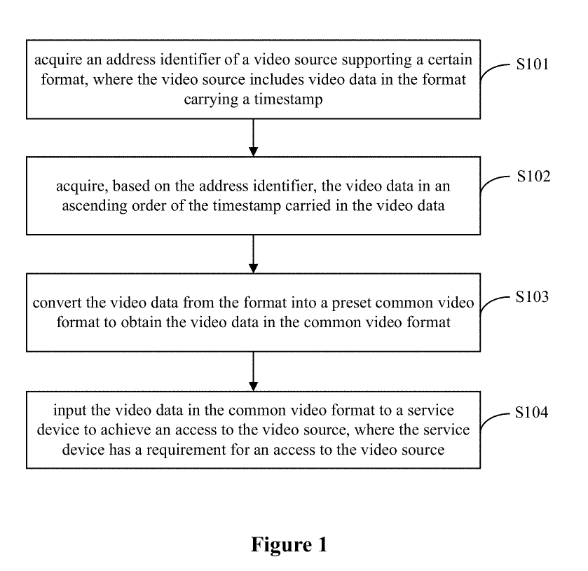

Reference is made to FIG. 1, which is a flowchart of a video source access method according to an embodiment of the present disclosure. Specifically, the method may include steps S101 to S104.

In step S101, an address identifier of a video source supporting a certain format is obtained. The video source includes video data in the format carrying a timestamp.

In the embodiment, the video source access method may be applied to a video access server. The video access server may communicate with the service device according to a preset communication protocol. The service device mentioned in the embodiment may be considered as a video server, a video transcoding server or a video confluence server or the like, which has a requirement for an access to the video source.

The video source may include video data for live broadcasting, or a video file. In a word, the video source includes video data carrying a timestamp. The video access server may send an acquiring video data request to the video source upon reception of the address identifier of the video source.

It is to be noted that, the video source may support a video format such as fly, rtmp, and TS. Further, a new video format occurring with the development of video service may also be compatible with the video access server according to the present disclosure.

In step S102, the video data is obtained in an ascending order of the timestamp carried in the video data based on the address identifier.

In the embodiment, a correspondence between the video source and the address identifier is preconfigured by the video access server. That is, video data in the video source corresponding to the address identifier may be pulled actively based on the address identifier. The address identifier may be a uniform resource locator (URL address) and the like. For example, in a case that the address identifier is the uniform resource locator (URL address), the video access server may pull video data in the video source corresponding to the URL address based on the URL address.

Since the video data in the video source carries the timestamp, it indicates that the video data has a time order. Hence, in the embodiment, the video data in the video source is pulled in an ascending order of the timestamp, that is, video data with the timestamp indicated to be earlier in time is firstly pulled.

In step S103, the video data is converted from the format into a preset common video format to obtain the video data in the common video format.

In the embodiment, after the video data is obtained by the video access server, the video access server converts the video data from the format to a preset common video format, to obtain finally the video data in the common video format, so that the service device can read the video data directly.

In addition, to meet the requirement of the service device for a code rate and resolution of the video data, in the embodiment, the service device may also include a transcoding server, and the video access server may input the video data in the common video format to the transcoding server for transcoding. Alternatively, the service device may further include a confluence server, and the video access server may input the video data in the common video format to the confluence server for confluence.

In addition, to meet the requirement of some audio servers for audio data in the video source, in the embodiment, audio data may be separated from the video data and inputted to the audio server, after the video data is obtained.

In step S104, the video data in the common video format is inputted to a service device to achieve an access to the video source, where the service device has a requirement for an access to the video source.

In the embodiment, a communication protocol is preset between the video access server and the service device, and data interaction between the video access server and the service device is realized according to the communication protocol.

In practice, before inputting video data in the common video format in the video source which carries a minimum time stamp to the service device, the video access server firstly sends a starting video transmission request to the service device to notify the service device that there exists a video source to access to. After locally allocating channel resource to the video source, the service device returns a starting video response. Upon reception of the starting video response returned by the service, the video access server firstly sends the video data in the common video format in the video source which carries the minimum time stamp to the service device. Then the video access server sends video data in the common video format to the service device in an ascending order of the timestamp carried in the video data.

After inputting the video data in the common video format in the video source which carries the maximum time stamp to the service device, the video access server sends an ending video transmission notification to the service device to notify the service device that the video source transmission has ended.

Upon reception of an ending video transmission signal from a third-party device to which the video source belongs, the video access server sends the ending video transmission notification to the service device to notify the service device that the video source transmission has ended.

In addition, the video access server may further detect an availability of the video source based on the address identifier of the video source at a frequency corresponding to a preset time duration. For example, it is detected whether the video data in the video source transmitted to the video access server is interrupted. The video access server sends a pausing video transmission notification to the service device to notify the service device to pause reception of the video data in a case that it is detected by the video access server that the video source is unavailable. The video access server may further reacquire the video data in the video source based on the address identifier after the preset time duration. The video access server continues video transmission to the service device in a case that the video access server gets the video data in the video source again after the interruption.

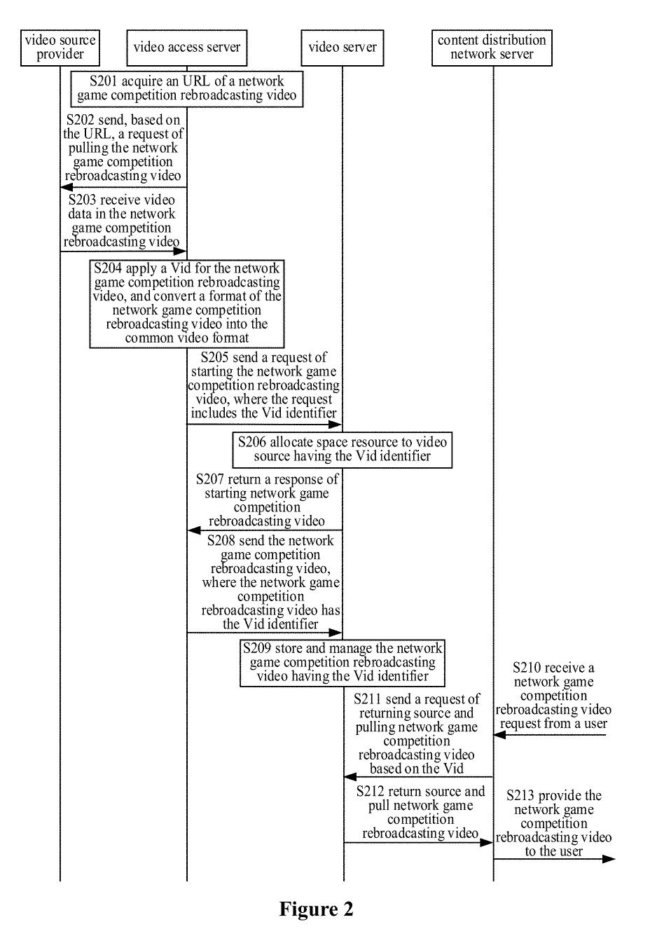

According to an optional embodiment of the present disclosure, the video access server may assign a unique video identifier (Vid) to the obtained video data. Upon reception of the video data, the service device manages and caches the received video data based on the video identifier, and a content distribution network server acquires the video data from the service device based on the video identifier. A communication protocol between the video access server and the service device may be preset. The protocol may include starting, transmission and ending of the video, and video data in different video sources are distinguished based on the Vid. Reference is made to FIG. 2, which is an interaction diagram of a video source access method applied to a big network game competition broadcasting according to an embodiment of the present disclosure. Specifically, the method includes steps S201 to S213.

In step S201, the video access server acquires a URL of the network game competition rebroadcasting video. The URL of the network game competition rebroadcasting video may be obtained in many ways.

Taking rebroadcasting of finals of Korea OGN Summer Season Tournament as an example in the embodiment of the present disclosure, the company may post a team to Korea for performing direct broadcasting satellite. The satellite signal is transmitted to China to generate a RTMP video stream as a video source for broadcasting. The video access server may acquire a URL of the RTMP video stream in advance.

In step S202, the video access server sends a request of pulling the network game competition rebroadcasting video to a video provider based on the URL.

In step S203, the video provider sends video data in the network game competition rebroadcasting video to the video access server upon reception of the request. The video data carries a timestamp.

In step S204, the video access server applies a Vid for the network game competition rebroadcasting video, and converts a format of the network game competition rebroadcasting video into the common video format.

In addition, the video access server may further separate the network game competition rebroadcasting video into two parts of video data and audio data by using software such as ffmpeg, input the video data to a video server, and input the audio data to an audio server. The video data is sent to a transcoding server for transcoding in a case that there is a requirement for a code rate and resolution in match rebroadcasting.

In step S205, the video access server sends a request of starting the network game competition rebroadcasting video to the video server. The request includes a Vid identifier of the network game competition rebroadcasting video.

In step S206, the video server allocates space resource to video source having the Vid identifier upon reception of the request.

In step S207, after allocating the space resource to the video source having the Vid, the video server returns a response of starting network game competition rebroadcasting video to the video access server to notify the video access server to start to transmit the network game competition rebroadcasting video.

In step S208, the video access server sends the network game competition rebroadcasting video to the video server. The network game competition rebroadcasting video has the Vid identifier.

In step S209, the video server stores and manages the network game competition rebroadcasting video having the Vid identifier.

In step S210, a content distribution network server (CDN) receives a network game competition rebroadcasting video request from a user.

In practice, when the user wants to watch a video, a device of the user is firstly connected to a nearest CDN server, and the CDN server checks whether the video source is cached locally. If the video source is not in a local cache, the CDN server requests a returning source server for an address of the video server where the video source is located and requests the video server for video data in the video source.

In step S211, a request of returning source and pulling network game competition rebroadcasting video is sent to the video server based on the Vid of the video source requested by the user.

In step S212, a requirement of the CDN server for returning source and pulling network game competition rebroadcasting video is met upon reception of the request by the video server.

In step S213, the CDN server provides the network game competition rebroadcasting video to the user after the video data in the network game competition rebroadcasting video is pulled by the CDN server.

In addition, the video access server may detect an availability of the video source provided by the video provider periodically, send an alarm when it is found that video data is interrupted, and reconnect the video source from the video provider.

In embodiments of the present disclosure, an address identifier of a video source in any format is obtained in advance. The video source includes video data in the format carrying a timestamp; the video data is obtained in an ascending order of the timestamp carried in the video data based on the address identifier. The video data is converted from the format into a preset common video format to obtain the video data in the common video format. The video data in the common video format is inputted to a service device which has a requirement for an access to the video source. Compared with the conventional technology, in the present disclosure, the video source are converted from multiple formats into a common format without modifying a processing logic of the service device, the identifiable video data in the common format is provided to the service device, and access to the video source supporting various formats is achieved.

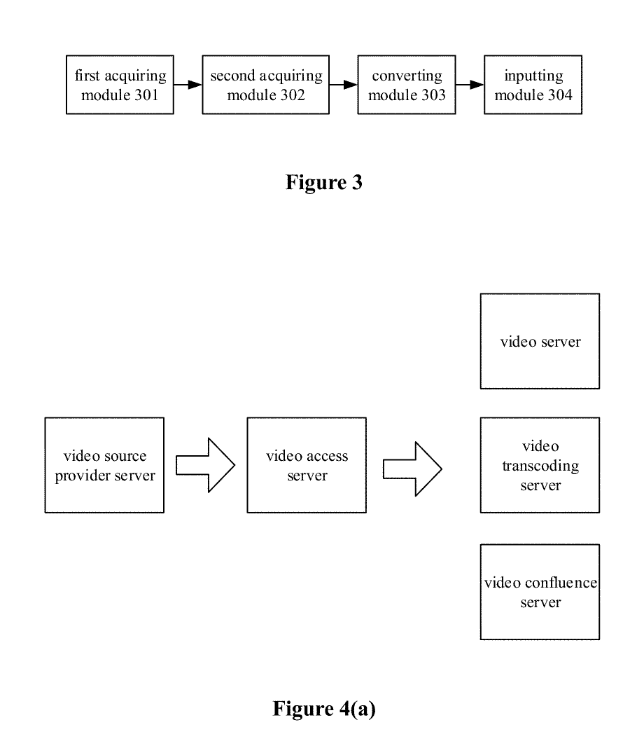

Reference is made to FIG. 3, which is a schematic structural diagram of a video source access device according to a device embodiment of the present disclosure. The device may include a first acquiring module 301, a second acquiring module 302, a converting module 303 and an inputting module 304.

The first acquiring module 301 is configured to acquire an address identifier of a video source supporting a certain format. The video source includes video data in the format carrying a timestamp.

The second acquiring module 302 is configured to acquire, based on the address identifier, the video data in an ascending order of the timestamp carried in the video data.

The converting module 303 is configured to convert the video data from the format into a preset common video format to obtain the video data in the common video format.

The inputting module 304 is configured to input the video data in the common video format to a service device to achieve an access to the video source, where the service device has a requirement for an access to the video source.

To realize the communication protocol between the device and the service device, the device further includes a first sending module configured to send a turn-on video transmission request to the service device.

The inputting module is further configured to input the video data in the common video format to the service device in an ascending order of the timestamp upon reception of a starting video response returned by the service device.

In addition, the device further includes a first detecting module and a second sending module.

The first detecting module is configured to detect an availability of the video source based on the address identifier.

The second sending module is configured to send a pausing video transmission notification to the service device in a case that it is detected that the video source is unavailable.

In addition, the device further includes a second detecting module and a third acquiring module.

The second detecting module is configured to detect an availability of the video source based on the address identifier.

The third acquiring module is configured to reacquire the video data in the video source based on the address identifier after a preset time duration in a case that it is detected that the video source is unavailable.

To notify the service device to end a video inputting operation, the device further includes a third sending module. The third sending module is configured to send an ending video transmission notification to the service device when an ending video transmission signal is received or after video data in the common video format in the video source which carries a maximum time stamp is inputted to the service device.

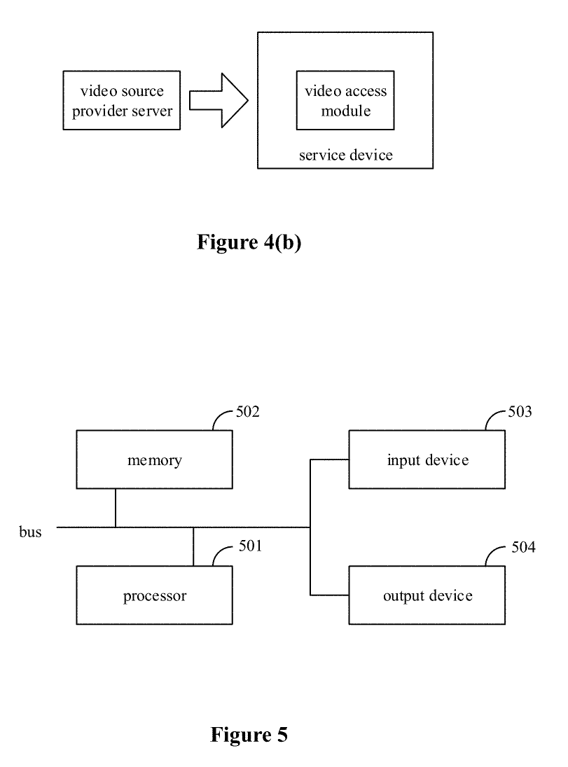

Reference is made to FIG. 4(a) and FIG. 4(b), which are deployment structural diagrams of video source access devices according to device embodiments of the present disclosure. FIG. 4(a) shows that the device may be implemented as an independent video access server, where the video access server may communicate with a service device such as a video server, a video transcoding server and a video confluence server. FIG. 4(b) shows that the device may also be implemented as an independent video access module and integrated into the service device, without affecting internal service logic of the service device.

Correspondingly, a server is provided according to an embodiment of the present disclosure. As shown in FIG. 5, the server can include a processor 501, a memory 502, an input device 503 and an output device 504.

The number of the processor 501 in the video access server in the embodiment of the present disclosure may be one or more, taking one processor as an example in FIG. 5. In some embodiments of the present disclosure, the processor 501, the memory 502, the input device 503 and the output device 504 may be connected via a bus or by other means, taking bus connection as an example in FIG. 5.

The memory 502 may be used to store software program and a module. The processor 501 executes various function applications and data processing of the video access server by running the software program and the module stored in the memory 502. The memory 502 may mainly include a program storage area and a data storage area. The program storage area may store an operation system, an application program required for at least one function and the like. The memory 502 may include a high-speed random access memory, and may further include a non-volatile memory, such as at least one disk storage device, a flash device or other volatile solid-state storage device. The input device 503 may be used to receive video data in the video source and the like.

Specifically, in the embodiment, the processor 501 may load one or more executable files corresponding to courses of application programs to the memory 502 and run the application program stored in the memory 502 to realize various functions, in accordance with the following instructions: acquiring an address identifier of a video source supporting a certain format, where the video source includes video data in the format carrying a timestamp; acquiring, based on the address identifier, the video data in an ascending order of the timestamp carried in the video data; converting the video data from the format into a preset common video format to obtain the video data in the common video format; and inputting the video data in the common video format to a service device which has a requirement for an access to the video source.

In some embodiments, the method may further include sending a starting video transmission request to the service device, and inputting the video data in the common video format to the service device in an ascending order of the timestamp upon reception of a starting video response returned by the service device.

In some embodiments, the method may further include detecting an availability of the video source based on the address identifier, and sending a pausing video transmission notification to the service device in a case that it is detected that the video source is unavailable.

In some embodiments, the method may further include detecting an availability of the video source based on the address identifier, and reacquiring the video data in the video source based on the address identifier after a preset time duration in a case that it is detected that the video source is unavailable.

In some embodiments, an ending video transmission notification may be sent to the service device when an ending video transmission signal is received or after video data in the common video format in the video source which carries a maximum time stamp is inputted to the service device.

Correspondingly, a computer-readable storage media is further provided in an embodiment of the present disclosure. The computer-readable storage media has program instructions stored therein. The program instructions, when executed by a processor of a computing device, configure the computing device to: acquire an address identifier of a video source supporting a certain format, where the video source includes video data in the format carrying a timestamp; acquire, based on the address identifier, the video data in an ascending order of the timestamp carried in the video data; convert the video data from the format into a preset common video format to obtain the video data in the common video format; and input the video data in the common video format to a service device to achieve an access to the video source.

The embodiments of the device substantially correspond to the embodiments of the method. Therefore, relevant portions may be referred to the description for the embodiments of the method. The above-described embodiments of the device are merely illustrative. A unit described as a separated part may be or may not be physically separated. A part shown in a unit may be or may not be a physical unit, i.e. a part shown in a unit may be located in one place or may be distributed to multiple network units. A part or all of the modules may be chosen as required to achieve the object of the solution of the embodiment.

It should be noted that, the relationship terminologies such as first and second and the like are only used herein to distinguish an entity or operation from another entity or operation, and it is not necessarily required or implied that there are any actual relationship or order of this kind between those entities and operations. Moreover, the terminologies of ‘comprise’, ‘include’, and any other variants are intended to cover the non-exclusive contains so that the processes, methods, articles or equipment including a series of elements not only include those elements but also include other elements that are not listed definitely or also include the elements inherent in the processes, methods, articles or equipment. In the case of no more restrictions, the elements defined by the statement ‘include one . . . ’ do not exclude that other same elements also exist in the processes, methods, articles or equipment including the elements.

The video source access method and a device thereof according to the embodiments of the disclosure are introduced in detail above, the principles and implementing ways of the disclosure are clarified by specific examples, and the above illustration of the embodiments is only to help to understand the method and key idea of disclosure. In addition, those skilled in the art may make changes to the specific embodiments and the application scope based on the idea of the disclosure. In summary, the specification should not be understood as limitations to the disclosure.

1. A video source access method, comprising:
acquiring an address identifier of a video source supporting a certain format, wherein the video source comprises video data in the format carrying a timestamp;
acquiring, based on the address identifier, the video data in an ascending order of the timestamp carried in the video data;
converting the video data from the format into a preset common video format to obtain the video data in the common video format; and
inputting the video data in the common video format to a service device to achieve an access to the video source,
wherein the method is performed by a video server.

2. The method according to claim 1, further comprising sending a starting video transmission request to the service device,
wherein inputting the video data in the common video format to the service device comprises inputting the video data in the common video format to the service device in an ascending order of the timestamp upon reception of a starting video response returned by the service device.

3. The method according to claim 1, further comprising:
detecting an availability of the video source based on the address identifier; and
sending a pausing video transmission notification to the service device in a case that it is detected that the video source is unavailable.

4. The method according to claim 1, further comprising:
detecting an availability of the video source based on the address identifier; and
reacquiring the video data in the video source based on the address identifier after a preset time duration in a case that it is detected that the video source is unavailable.

5. The method according to claim 1, wherein an ending video transmission notification is sent to the service device when an ending video transmission signal is received or after video data in the common video format in the video source which carries a maximum time stamp is inputted to the service device.

6. The method according to claim 1, further comprising assigning a unique video identifier to the video source.

7. The method according to claim 1, further comprising setting a communication protocol, and inputting the video data in the common video format to the service device in accordance with the communication protocol.

8. The method according to claim 1, further comprising sending an acquiring video data request to the video source after the address identifier of the video source is obtained.

9. The method according to claim 1, further comprising separating audio data from the obtained video data, and inputting the audio data to an audio server.

10. The method according to claim 1, wherein the service device comprises at least one of a video server, a video transcoding server or a video confluence server.

11. A video source access device comprising one or more processors and a memory for storing program instructions, wherein the one or more processors are configured to execute the program instructions to:
acquire an address identifier of a video source supporting a certain format, wherein the video source comprises video data in the format carrying a timestamp;
acquire, based on the address identifier, the video data in an ascending order of the timestamp carried in the video data;
convert the video data from the format into a preset common video format to obtain the video data in the common video format; and
input the video data in the common video format to a service device to achieve an access to the video source.

12. The device according to claim 11, wherein the one or more processors are further configured to execute the program instructions to:
send a starting video transmission request to the service device, and
input the video data in the common video format to the service device in an ascending order of the timestamp upon reception of a starting video response returned by the service device.

13. The device according to claim 11, wherein the one or more processors are further configured to execute the program instructions to:
detect an availability of the video source based on the address identifier; and
send a pausing video transmission notification to the service device in a case that it is detected that the video source is unavailable.

14. The device according to claim 11, wherein the one or more processors are further configured to execute the program instructions to:
detect an availability of the video source based on the address identifier; and
reacquire the video data in the video source based on the address identifier after a preset time duration in a case that it is detected that the video source is unavailable.

15. The device according to claim 11, wherein the one or more processors are further configured to execute the program instructions to:
send an ending video transmission notification to the service device when an ending video transmission signal is received or after video data in the common video format in the video source which carries a maximum time stamp is inputted to the service device.

16. A non-transitory computer-readable storage media comprising computer executable instructions that, when executed by a processor, cause the processor to perform the following operations:
acquiring an address identifier of a video source supporting a certain format, wherein the video source comprises video data in the format carrying a timestamp;
acquiring, based on the address identifier, the video data in an ascending order of the timestamp carried in the video data;
converting the video data from the format into a preset common video format to obtain the video data in the common video format; and
inputting the video data in the common video format to a service device to achieve an access to the video source.

17. The non-transitory computer-readable storage media according to claim 16, wherein the operations further comprise:
sending a starting video transmission request to the service device, and
inputting the video data in the common video format to the service device in an ascending order of the timestamp upon reception of a starting video response returned by the service device.

18. The non-transitory computer-readable storage media according to claim 16, wherein the operations further comprise:
detecting an availability of the video source based on the address identifier; and
sending a pausing video transmission notification to the service device in a case that it is detected that the video source is unavailable.

19. The non-transitory computer-readable storage media according to claim 16, wherein the operations further comprise:
detecting an availability of the video source based on the address identifier; and
reacquiring the video data in the video source based on the address identifier after a preset time duration in a case that it is detected that the video source is unavailable.

20. The non-transitory computer-readable storage media according to claim 16, wherein the operations further comprise:
sending an ending video transmission notification to the service device when an ending video transmission signal is received or after video data in the common video format in the video source which carries a maximum time stamp is inputted to the service device.
